(19) United States
(12) Patent Application Publication
(10) Pub. No.: US 2004/0144616 A1
(43) Pub. Date: Jul. 29, 2004

(54) Multi-friction roller for a material handling system

(76) Inventor: Michael A. Leon, Orlando, FL (US)

Correspondence Address: COLLIER SHANNON SCOTT, PLLC, 3050 K STREET, NW, SUITE 400, WASHINGTON, DC, 20007, US

(21) Appl. No.: 10/351,411

(22) Filed: Jan. 27, 2003

(51) Int. Cl. B65G 13/00

(52) U.S. Cl. 193/35 MD

(57) ABSTRACT

The present invention relates generally to material handling systems. In particular, the present invention relates to a non-homogenous roller having a plurality of friction coefficients for use in a material handling system. The roller may comprise an inner sleeve defining a bore for receiving a roller shaft, wherein the inner sleeve comprises a first material having a first coefficient of friction; and an outer body formed around said inner sleeve, wherein the outer body comprises a second material having a second coefficient of friction.

### FIELD OF THE INVENTION

The present invention relates generally to material handling systems. In particular, the present invention relates to a roller having a plurality of friction coefficients for use in a material handling system.

### BACKGROUND OF THE INVENTION

Material handling systems are useful for transferring various articles between two positions. These systems may be used in a variety of environments, including airports, loading docks, shipping yards, warehouses, and other similar locations.

Friction is an important factor in the performance of any material handling system. Frictional forces may be especially critical in material handling conveyor systems which comprise multiple cluster roller assemblies attached to drive shafts with each cluster having a number of freely rotatable rollers arranged around the periphery of the cluster, such as systems of the type disclosed and claimed in U.S. Pat. Nos. 5,064,045 and 6,360,865, assigned to FMC Corporation, the disclosures of which are incorporated herein by reference. These conveyor systems are capable of translating or rotating an article in various directions by selectively controlling the direction of rotation of the shafts on which the clusters are attached.

Friction may also be crucial in material handling systems which comprise multidirectional helical roller assemblies, such as systems of the type disclosed and claimed in U.S. Pat. No. 6,244,417, assigned to FMC Corporation, the disclosure of which is incorporated herein by reference. In addition, friction plays a critical role in the operation of material handling systems using idler rollers, interface rollers, straight rollers, and weight bearing rolling elements.

For the above described systems, or any other material handling system, to accurately convey their loads, however, the rollers must turn immediately upon contact with approaching loads. These loads may vary significantly from a few pounds to several hundreds of pounds per roller. In order for the roller to operate properly under these varying loads, the roller bore friction must remain below the roller-to-load friction at the outside diameter of the roller. This friction relationship may be necessary not only to allow the roller to convey the cargo, but also to position the cargo precisely.

Some known material handling systems provide a one-piece, homogenous roller to handle the required loads. With many of these rollers, however, the bore friction remains high. A high bore friction may cause both the center bore and outer diameter wear rates to increase, leading to decreased roller performance. A compromise in material property has to be made between not providing enough friction at the roller outer diameter to move the cargo and providing too much internal friction to allow the rollers to turn freely in all load conditions.

Other known material handling systems attempt to resolve these friction issues by providing rollers that incorporate bushings or roller bearings inserted within the roller bore. These rollers, however, may have a life limited by the amount of built-in lubrication provided. Lubrication may be added manually during routine maintenance, but ultimately the complete roller assemblies must be replaced. In addition, changes in temperature and humidity may cause the inserted components to migrate toward the center of the roller, causing performance issues. The additional roller components themselves, their maintenance, and their replacement may significantly increase the cost of manufacturing and operating a material handling system.

Even with the inserted components, many rollers themselves are made of materials that suffer from outer diameter wear. As a result, the roller may be unable to keep the load off other non-bearing components of the material handling system. This may lead to costly system damage and further reduced performance. In addition, material handling systems are typically operated under a wide range of adverse weather conditions and are often exposed to significant contaminants. These conditions can also propagate roller wear and lead to significant performance issues.

The roller and related material handling systems of the present invention are adapted to operate properly under various loads and operating conditions and provide a roller bore friction that is below the roller-to-load friction at the outside diameter of the roller. Accordingly, embodiments of the roller and related material handling systems of the present invention may provide increased system performance and life at a reduced cost. Additional advantages of embodiments of the invention are set forth, in part, in the description which follows and, in part, will be apparent to one of ordinary skill in the art from the description and/or from the practice of the invention.

### SUMMARY OF THE INVENTION

Applicant has developed an innovative non-homogenous roller for use with a material handling system that provides a roller-to-bore friction at the inside diameter that is below the roller-to-load friction at the outside diameter of the roller. The roller may be rotationally mounted on a roller shaft, and may comprise: an inner sleeve defining a bore for receiving the roller shaft, the inner sleeve comprising a first material having a first coefficient of friction; and an outer body formed around the inner sleeve, the outer body comprising a second material having a second coefficient of friction. The second coefficient of friction may be greater than the first coefficient of friction. The outer body may be composed of Nylon. The inner sleeve may be composed of Nylon, Molybendum, and Graphite. In one embodiment, the material handling system may further comprise a cluster roller assembly. In another embodiment, the material handling system may further comprise a helical roller assembly. The roller may comprise a weight bearing roller element.

Applicant has further developed an innovative material handling system for translation or rotation of an article. The system may comprise: a frame having a plurality of drive shafts rotatably mounted thereon, wherein each drive shaft includes at least one body member; and a plurality of rollers supported by the body member, each of the rollers comprising: an inner sleeve defining a bore for receiving a roller shaft, the inner sleeve comprising a first material having a first coefficient of friction; and an outer body formed around the inner sleeve, the outer body comprising a second material having a second coefficient of friction.

Applicant has also developed an innovative material handling system comprising: a frame; a driven shaft rotatably mounted on the frame; a body member mounted on the driven shaft having a periphery and a plurality of roller support positions along the periphery; and a plurality of rollers rotatably mounted on a roller shaft at each of the roller support positions, each of the rollers comprising: an inner sleeve defining a bore for receiving the roller shaft, the inner sleeve made of a first material having a first coefficient of friction; and an outer body formed around the inner sleeve, the outer body made of a second material having a second coefficient of friction.

Applicant has developed a material handling system that permits translation or rotation of an article, comprising: a frame; a plurality of drive shafts rotatably mounted on the frame and positioned substantially parallel to each other, wherein each drive shaft includes a plurality of cluster roller assemblies mounted thereon. The cluster roller assemblies each may comprise: a body member having a periphery and a plurality of roller support positions along the periphery; a roller shaft retained at each of the roller support positions; and a roller rotatably mounted on the roller shaft at each of the roller support positions, each roller comprising: an inner sleeve defining a bore for receiving the roller shaft, the inner sleeve made of a first material having a first coefficient of friction; and an outer body formed around the inner sleeve, the outer body made of a second material having a second coefficient of friction.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

In order to assist the understanding of this invention, reference will now be made to the appended drawings, in which like reference numerals refer to like elements. The drawings are exemplary only, and should not be construed as limiting the invention.

FIG. 1 is an end view of a non-homogenous roller according to a first embodiment of the present invention.

FIG. 2 is a sectional view of the roller in FIG. 1 taken along line 2-2.

FIG. 3 is an isometric view of a roller according to an embodiment of the present invention.

FIG. 4 is a sectional view of a roller according to a second embodiment of the present invention.

FIG. 5 is a sectional view of a roller according to a third embodiment of the present invention.

FIG. 6 is a sectional view of a roller according to a fourth embodiment of the present invention.

FIG. 7 is a plan view of a cluster roller assembly according to an embodiment of the present invention.

FIG. 8 is an isometric view of a cluster roller assembly according to another embodiment of the present invention.

FIG. 9 is an expanded view illustrating the mounting of a roller to a cluster roller assembly according to an embodiment of the present invention.

FIG. 10 is a plan view of a drive shaft used in a material handling system according to an embodiment of the present invention.

FIG. 11 is a top plan view of a material handling system according to an embodiment of the present invention.

FIG. 12 is an isometric and partial cutaway view of a multidirectional helical roller assembly according to an embodiment of the present invention.

FIG. 13. is a top plan view of a portion of a material handling system according to an embodiment of the present invention.

FIG. 14 is a sectional view of a straight roller according to an embodiment of the present invention.

### DETAILED DESCRIPTION OF PREFERRED EMBODIMENTS OF THE INVENTION

Reference will now be made in detail to embodiments of the present invention, an example of which is illustrated in the accompanying drawings. As embodied herein, the present invention includes a roller 10 for use with a material handling system 100.

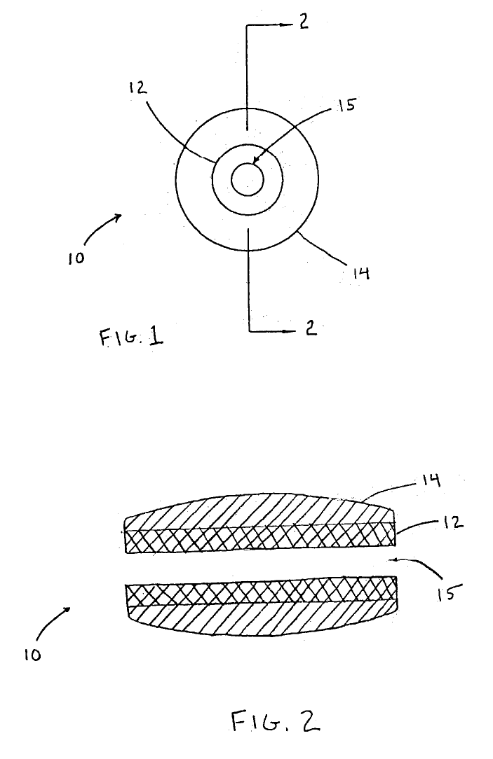

With reference to FIG. 1, the roller 10 comprises an inner sleeve 12 and an outer body 14 formed around the inner sleeve 12. The roller 10 may be manufactured such that the inner sleeve 12 and the outer body 14 form one piece. The inner sleeve 12 defines a bore 15 for receiving a roller shaft (not shown) about which the roller 10 is adapted to rotate. The inner sleeve 12 provides an inner sleeve contact surface for contacting the roller shaft. The outer body 14 provides an outer body contact surface for contacting a surface, including, but not limited to: an article being handled, the ground, or an element of the material handling system 100, such as, for example, a conveyor platform, or a frame. It is contemplated, however, that in other embodiments of the roller 10, the outer body 14 may provide an outer body contact surface for contacting any other surface.

In one embodiment, as shown in FIGS. 2 and 3, the outer body 14 has a convex outer surface and the roller 10 may have an overall barrel-shaped configuration. In this manner, the outside diameter of the roller 10 is greatest at the center of the roller 10 and gradually decreases toward the ends of the roller 10. The roller 10 may be symmetric about its transverse axis, as well as about its axis of rotation.

In one embodiment, the roller 10 is non-homogenous. The inner sleeve 12 and the outer body 14 may be composed of at least one different material. Alternatively, the inner sleeve 12 and the outer body 14 may be composed of different grades of the same material. The outer body 14 material may have a coefficient of friction that is not equal to the coefficient of friction of the inner sleeve 12 material, and preferably, the outer body 14 material has a coefficient of friction that is greater than the coefficient of friction of the inner sleeve 12 material. It is contemplated that the term coefficient of friction may be construed broadly to encompass any one or more types of coefficients of friction, including, but not limited to, kinetic coefficient, static coefficient, deformation coefficient, molecular coefficient, rolling coefficient, and/or any other type of coefficient of friction used in scientific fields. As will be apparent to those of ordinary skill in the art, it is further appreciated that comparative references of the inner sleeve 12 material coefficient of friction with the outer body 14 material coefficient of friction are relative to the same scale, criteria, or standard.

In one embodiment, the outer body 14 comprises Nylon, and the inner sleeve 12 comprises Nylon. The inner sleeve 12 may further comprise Graphite and Molybdenum. In one embodiment, the outer body 14 and the inner sleeve 12 may comprise Nylon 6. The outer body 14 and the inner sleeve 12 may comprise Nylon 6 per ASTM D4066, Group 2, Class 2, Grade 6, Anti-Static blend, Hardness D85. Other compositions of the inner sleeve 12 and the outer body 14, including other types of Nylon, are considered to be within the scope of the present invention. In one embodiment, the outer body 14 may further comprise UV stabilizers to prolong the life of the roller 10 in the sun and prevent cracking of the outer body 14 contact surface. As discussed below, in one embodiment, the inner sleeve 12 material and the outer body 14 material may have approximately the same melting temperatures.

In one embodiment of the present invention, the inner sleeve 12 may further comprise a flange 13, as shown in FIGS. 4 and 5. In this manner, the ends of the roller 10 may have a coefficient of friction that is not equal to the coefficient of friction of the outer body 14 material, and preferably, the ends of the roller 10 may have a coefficient of friction that is less than the coefficient of friction of the outer body 14 material. The flange 13 may allow the friction between the ends of the roller 10 and other system components, such as, for example, a roller support, to be below the roller friction at the outside diameter of the roller 10. In one embodiment of the present invention, the flange 13 may be contained within the outer body 14, as shown in FIG. 4. Alternatively, the flange 13 may extend beyond the outer body 14, as shown in FIG. 5.

In another embodiment of the present invention, the roller 10 may further comprise a flat washer 40 formed within the roller 10, as shown in FIG. 6. The washer 40 may be comprised of an engineering plastic, such as, for example, Polyoxymethylene (POM)-Acetal, or any other suitable material capable of providing a friction between the ends of the roller 10 and other system components, such as, for example, a roller support, that is below the friction at the outside diameter of the roller 10.

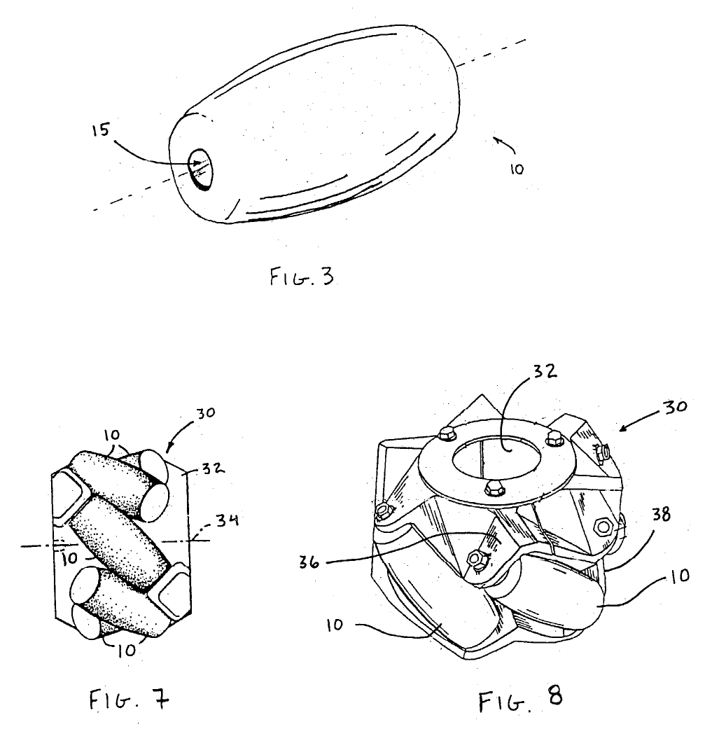

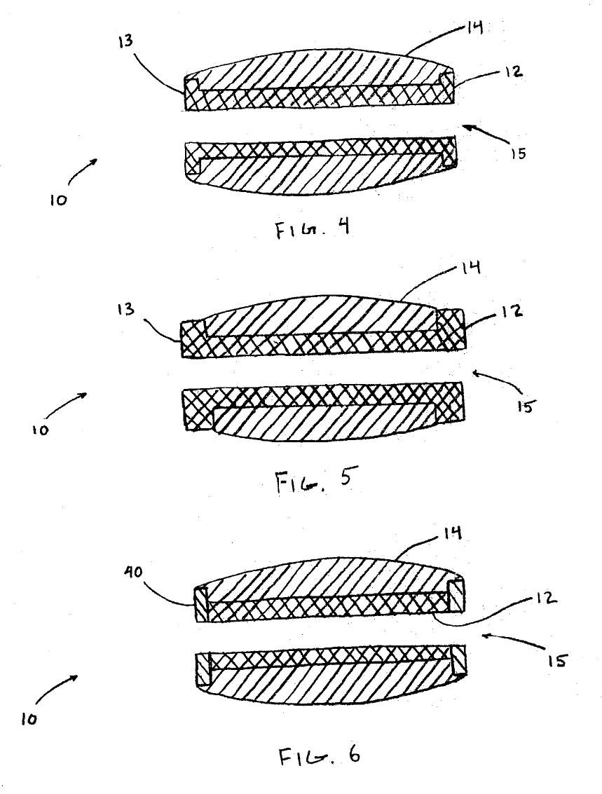

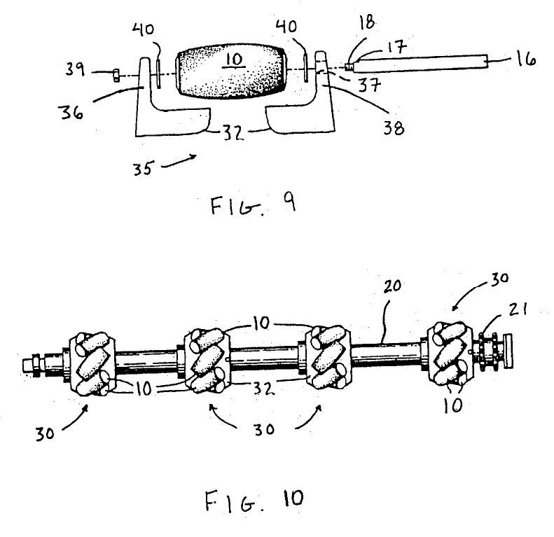

The roller 10 may be used in conjunction with a material handling system 100. In one embodiment, the material handling system may comprise a cluster roller assembly 30, such as, for example, a cluster roller assembly 30 as disclosed in U.S. Pat. Nos. 5,064,045 and 6,360,865, assigned to FMC Corporation, the disclosures of which are incorporated herein by reference in their entirety. Examples of the cluster roller assembly 30 are shown in FIGS. 7 and 8.

In one embodiment, as shown in FIGS. 7 and 8, the cluster roller assembly 30 comprises a plurality of rollers 10 arranged around the periphery of and supported by a body 32 at an acute angle, such as, for example, approximately 45 degrees, relative to the axis 34 of the cluster roller assembly 30. The rollers 10 may be shaped to essentially define the surface of the central portion of a sphere and comprise the surfaces contacting the article being handled, or an element of the material handling system 100, such as, for example, a conveyor platform.

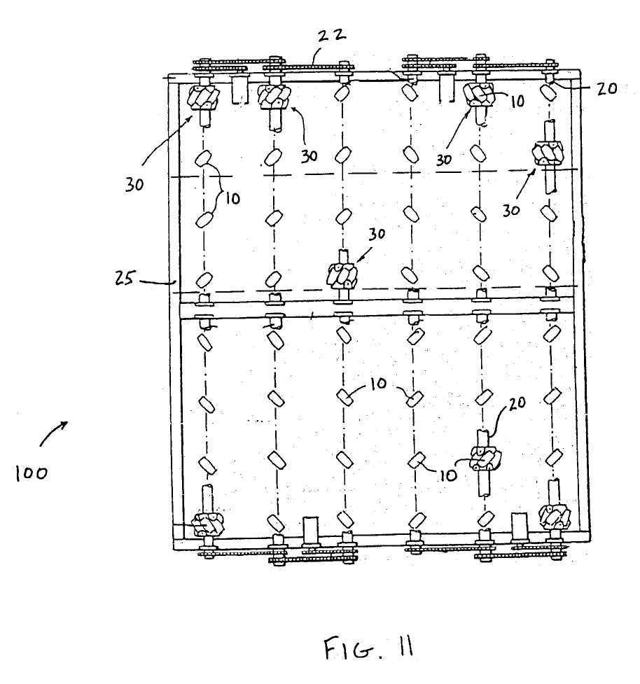

With reference to FIG. 9, each roller 10 may be mounted for rotation on a roller shaft 16 at each of a plurality of roller support positions 35 formed along the periphery of the body 32. Each roller support position 35 may include a pair of outward-extending legs 36 and 38 formed on the body 32. The roller shaft 16 may extend through the bore 15 between the legs 36 and 38. The roller shaft 16 is retained in this position and is restrained from rotation by a flat 17 formed on one end of the roller shaft 16, the end of which terminates in a reduced diameter threaded portion 18. The leg 36 may include a D-shaped hole (not shown), which intersects with a bore (not shown) extending from the inner surface of the leg 36. The bore is slightly larger than the major diameter of the shaft 16, as is an aligned bore 37 formed in the opposite leg 38. For assembly, the threaded end of the roller shaft 16 is inserted through the bore 37, the bore 15 of the roller 10, and the bore in the leg 36, such that the flat 17 engages the D-shaped hole. A locking nut 39 engages the threaded end 18 to hold the assembly in place.

In one embodiment, as shown in FIG. 9, the cluster roller assembly 30 may further comprise flat washers 40 positioned on the roller shaft 16 between the ends of the roller 10 and the inner side of the legs 36 and 38, as disclosed in the aforementioned '045 patent assigned to FMC Corporation. In another embodiment, the cluster roller assembly 30 may further comprise rolling element bearings and a flat between the ends of the roller 10 and the inner side of the legs 36 and 38, as disclosed in the aforementioned '865 patent assigned to FMC Corporation. In yet another embodiment, as discussed above with reference to FIGS. 4-6, the inner sleeve 12 may further comprise a flange 13, and/or the ends of the roller 10 may have a washer 40 formed within the roller 10.

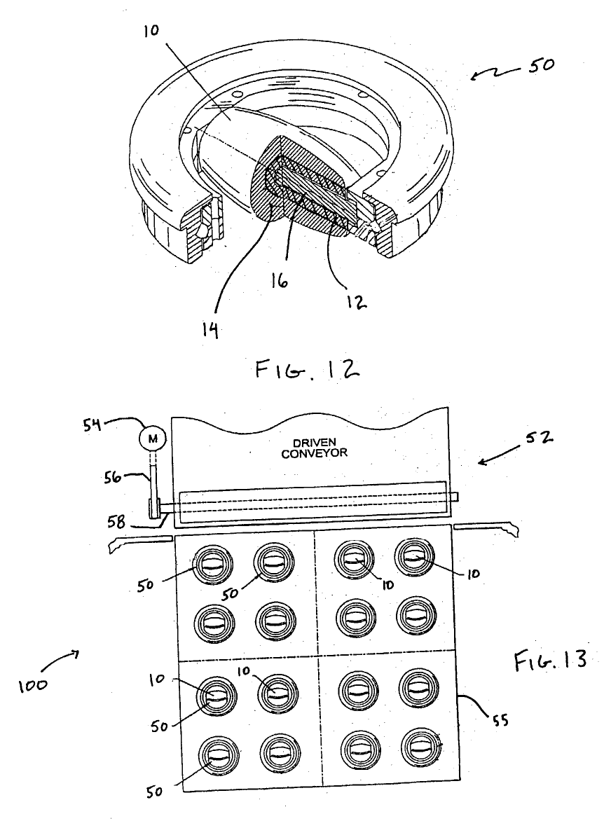

With reference to FIGS. 10 and 11, the material handling system 100 may further comprise a plurality of drive shafts 20 rotatably mounted on a frame 25 and selectively driven by a chain 22 trained over a sprocket 21 and a sprocket affixed to and driven by a reversible motor (not shown), as described in the aforementioned U.S. patents assigned to FMC Corporation. A plurality of cluster roller assemblies 30 may be mounted on the drive shaft 20 for rotation therewith.

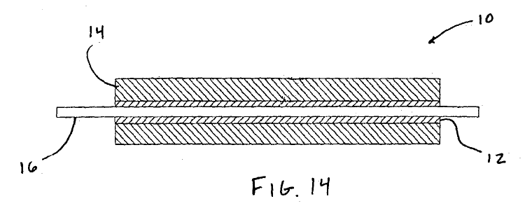

In another embodiment of the present invention, the material handling system 100 may comprise a helical roller assembly 50, such as, for example, a helical roller assembly 50 as disclosed in U.S. Pat. No. 6,244,417, assigned to FMC Corporation, the disclosure of which is incorporated herein by reference in its entirety. An example of the helical roller assembly 50 is shown in FIG. 12. With reference to FIG. 13, the material handling system 100 may further comprise a conveyor system 52 driven by a motor 54 having a belt drive 56 engaging a roller shaft 58, and a platform 55, as disclosed in the aforementioned '417 patent. The platform 55 may include a plurality of helical roller assemblies 50. It is contemplated that the platform 55 may include a plurality of cluster roller assemblies 30.

In another embodiment, as shown in FIG. 14, the roller 10 may be a straight roller. The outer body 14 may be straight, as opposed to barrel shaped, and may be formed around the inner sleeve 12 which rotates about a fixed shaft 16. In one embodiment, the roller 10 may be used in conjunction with a material handling system 100 as an idler roller. The idler roller 10 may be non-powered and may be used to support a load being conveyed, for example, as it is manually pushed across the idler roller 10. In another embodiment, the roller 10 may be used in conjunction with a material handling system 100 as an interface roller. The interface roller 10 may be non-powered and may be used to bridge a gap between two conveying surfaces, such as, decks and/or platforms. It is contemplated that embodiments of the roller 10 may also be used in other appropriate non-powered applications.

Embodiments of the roller 10 of the present invention may be used in conjunction with numerous material handling systems 100. Embodiments of the roller 10 of the present invention may be used in conjunction with Assignee's material handling systems, including, but not limited to, Commander-15 loader, Commander-30 loader, HTD/RA transfer deck, HTD/CR transfer deck, HTD/PR transfer deck, CLT-8 transporter, and CPT-7ST transporter. It is appreciated that the roller 10 may be used in conjunction with other material handling systems, including systems outside the air cargo market.

The roller 10 may be manufactured such that the inner sleeve 12 and the outer body 14 form one piece. The inner sleeve 12 material may be formed over a mandrel and then the molten material of the outer body 14 may be injected over the inner sleeve 12 to form the outside surface of the roller 10. The inner sleeve 12 material and the outer body 14 material may have approximately the same melting temperatures. When the outer body 14 material is injected over the inner sleeve 12, the materials may melt together, and the cooling process is sufficiently rapid enough to eliminate complete mixing of the materials. As such, the majority of the desired friction properties of the materials are maintained in their desired locations. Other methods of manufacturing the roller 10 are considered within the scope of the present invention. For example, where both the inner sleeve 12 material and the outer body 14 material comprise Nylon, only the Graphite and Molybdenum of the inner sleeve 12 may be formed around a core surface. When the molten outer body 14 material is injected onto inner sleeve 12 material, it will absorb the Graphite and Molybdenum. The cooling time may be rapid enough to prevent the Graphite and Molybdenum from reaching the outer surface of the roller 10.

Embodiments of the present invention provide an innovative non-homogenous roller for use with a material handling system that provides a roller bore friction that is below the roller-to-load friction at the outside diameter of the roller. It will be apparent to those skilled in the art that variations and modifications of the present invention can be made without departing from the scope or spirit of the invention. For example, the roller 10 may be used as a weight bearing rolling element, wherein the roller 10 would serve as a wheel and bearing instead of having a load run across it. In this manner, the roller 10 may be used, for example, on the end of a scissor lift mechanism or as a bogy wheel. In addition, it is contemplated that the material handling system 100 may include any one or more of the embodiments of the roller 10 of the present invention in various combinations. Thus, it is intended that the present invention cover all such modifications and variations of the invention, provided they come within the scope of the appended claims and their equivalents.

What is claimed is:

1. In a material handling system, a roller rotationally mounted on a roller shaft, said roller comprising:
an inner sleeve defining a bore for receiving the roller shaft, said inner sleeve comprising a first material having a first coefficient of friction; and
an outer body formed around said inner sleeve, said outer body comprising a second material having a second coefficient of friction.

2. The roller of claim 1, wherein the second coefficient of friction is greater than the first coefficient of friction.

3. The roller of claim 1, wherein the second coefficient of friction is not equal to the first coefficient of friction.

4. The roller of claim 1, wherein the second material comprises Nylon.

5. The roller of claim 1, wherein the first material comprises Nylon.

6. The roller of claim 5, wherein the first material further comprises molybdenum and graphite.

7. The roller of claim 1, wherein the melting temperature of the first material is approximately equal to the melting temperature of the second material.

8. The roller of claim 1, wherein said outer body has a concave outer surface.

9. The roller of claim 1, wherein said outer body has a straight outer surface.

10. The roller of claim 1, wherein said roller is manufactured such that said inner sleeve and said outer body form one piece.

11. The roller of claim 1, wherein said inner sleeve comprises an inner sleeve contact surface for contacting the roller shaft.

12. The roller of claim 1, wherein said inner sleeve further comprises a flange.

13. The roller of claim 1, wherein said outer body comprises an outer body contact surface for an article to be moved.

14. The roller of claim 4, wherein said second material further comprises a UV stabilizer.

15. The roller of claim 1, wherein the material handling system further comprises a cluster roller assembly.

16. The roller of claim 1, wherein the material handling system further comprises a helical roller assembly.

17. The roller of claim 1, wherein said roller is a weight bearing rolling element.

18. A material handling system for translation or rotation of an article, comprising:
a frame having a plurality of drive shafts rotatably mounted thereon, wherein each drive shaft includes at least one body member; and
a plurality of rollers supported by the body member, each of said rollers comprising:
an inner sleeve defining a bore for receiving a roller shaft, said inner sleeve comprising a first material having a first coefficient of friction; and
an outer body formed around said inner sleeve, said outer body comprising a second material having a second coefficient of friction.

19. The system of claim 18, wherein the second coefficient of friction is greater than the first coefficient of friction.

20. The system of claim 18, wherein the second material comprises Nylon.

21. The system of claim 18, wherein the first material comprises Nylon, molybdenum, and graphite.

22. In a material handling system, the improvement comprising a non-homogenous roller comprising first and second materials, wherein the coefficient of friction of the first material is greater than the coefficient of friction of the second material.

23. A material handling system, comprising:
a frame;
a driven shaft rotatably mounted on said frame;
a body member mounted on said driven shaft having a periphery and a plurality of roller support positions along the periphery; and
a plurality of rollers rotatably mounted on a roller shaft at each of the roller support positions, each of said rollers comprising:
an inner sleeve defining a bore for receiving the roller shaft, said inner sleeve made of a first material having a first coefficient of friction; and
an outer body formed around said inner sleeve, said outer body made of a second material having a second coefficient of friction.

24. The material handling system of claim 23, wherein the second coefficient of friction is greater than the first coefficient of friction.

25. The material handling system of claim 23, wherein the second material comprises Nylon.

26. The material handling system of claim 23, wherein the first material comprises Nylon, molybdenum, and graphite.

27. The material handling system of claim 23, wherein the melting temperature of the first material is approximately equal to the melting temperature of the second material.

28. A material handling system that permits translation or rotation of an article, said system comprising:
a frame;
a plurality of drive shafts rotatably mounted on said frame and positioned substantially parallel to each other, wherein each drive shaft includes a plurality of cluster roller assemblies mounted thereon, said cluster roller assemblies each comprising:
a body member having a periphery and a plurality of roller support positions along the periphery;
a roller shaft retained at each of the roller support positions; and
a roller rotatably mounted on said roller shaft at each of the roller support positions, each roller comprising:
an inner sleeve defining a bore for receiving said roller shaft, said inner sleeve made of a first material having a first coefficient of friction; and
an outer body formed around said inner sleeve, said outer body made of a second material having a second coefficient of friction.
